(19) United States
(12) Patent Application Publication
(10) Pub. No.: US 2012/0153617 A1
(43) Pub. Date: Jun. 21, 2012

(54) CONNECTION ASSEMBLY

(76) Inventor: Francis Kay, Buckinghamshire (GB)

(21) Appl. No.: 13/386,495

(22) PCT Filed: May 11, 2010
(86) PCT No.: PCT/GB2010/050763

§ 371 Date: Mar. 12, 2012

(30) Foreign Application Priority Data
May 12, 2009 (GB) 0908123.3
Jul. 31, 2009 (GB) 0913336.4

(51) Int. Cl. F16L 25/06

(52) U.S. Cl. 285/420

(57) ABSTRACT

A connection assembly for connecting a pipe, rod or pole to a connector, the assembly comprising: a collet having at a first end thereof a collet head having at least one abutment and at the second end thereof a collet collar, the collet having a bore therethrough, the collet bore being dimensioned and configured to receive and fittingly engage the pipe, rod or pole, the collet head being resiliency deformable so as to impinge on the pipe, rod or pole when deformed inwardly, the collet being provided with at least one screw thread on the external surface of the collet; a collet holder having a collet holder bore therethrough, the collet holder bore being dimensioned and configured to receive the collet, the collet holder bore comprising at least one screw thread on the surface thereof which matches the thread of the collet; and optionally a collet deflector dimensioned and configured to receive an abutment of the collet; wherein in use the collet holder and collet are mutually rotatable about a collet screw thread and a collet holder screw thread to cause the collet to engage with the collet deflector, whereby the collet deflector impinges on an abutment of the collet head to deform the collet head, which thereby impinges on and grips the pipe, rod or tube. A connector for use with the connection assembly, and a kit comprising the assembly and connector, are also described.

### FIELD OF THE INVENTION

The present invention relates to a connection assembly and more particularly to a pipe connection assembly for connecting pipes that are capable of carrying fluid (liquid or gas). The pipe connection assembly of the invention may also be used to connect pipes, poles or rods for any other use, for example in the assembly of a pole-supported structure. In particular, the assembly may be used to connect poles for assembling a temporary structure, and in one embodiment the poles have the dual uses of structural support and circulation of fluid, for example carrying hot water for heating or cold water for cooling of the structure. The pipe connection assembly of the invention is also useful for connecting water-carrying pipes in an irrigation system, which may be a temporary or modular irrigation system. Further, the assembly can be used to connect tubes carrying electrical power cables, fibre-optic cables and the like.

### BACKGROUND OF THE INVENTION

There are many methods employed in the art for connecting fluid-carrying pipes such as simple screw thread arrangements, so called “nut and olive” assemblies and “push-grip” methods employing a split collet and using an O-ring to seal.

A nut and olive assembly is an example of a compression type fitting. The fitting comprises an outer compression nut and an inner compression ring which is also known as an “olive”. When the nut is tightened, it clamps down on the olive, causing it to conform to the circumference of the pipe, thereby sealing the joint.

However, once the joint is taken apart, it is possible to remove the pipe from the fitting assembly, but the olive remains permanently squeezed into the pipe. This type of compression fitting is also not especially robust against stresses such as flexing and bending of the pipe. In addition, when assembling the fitting, the olive must be oriented correctly outside the pipe, leading to a relatively complicated fitting process.

A “push-grip” assembly employs a collet which is pushed on to the pipe to be connected and clamps it. For the avoidance of doubt, a standard collet known in the art is a type of chuck that forms a collar around the object to be held (for example a drilling bit, but in the context of this specification, the object is a pipe, rod or tube) and exerts a strong clamping force on the object (pipe, rod or tube) when the collet is tightened via a tapered outer collar.

The push-grip assembly known in the art has an advantage over other connectors, in that it is possible to remove the pipe from its fitting, but to do this it is necessary push the exposed end of a collet in one direction to release the grip of the collet, whilst pulling the pipe in the opposite direction to effect removal. This need for pushing and pulling at the same time is very awkward.

In addition, for larger pipe systems, such as 15 mm or 22 mm water pipes for domestic or irrigation purposes, purely manual action for gripping and releasing the collet is very difficult, whilst for larger pipes, manual action is quite impossible.

### SUMMARY OF THE INVENTION

Accordingly there is a need in the art for an improved connection assembly. In short, the present invention uses a collet to join a pipe, rod, pole or similar to a connector. The collet of the present invention is provided with an external threaded portion, which is used to drive the closure of the collet required to grip the pipe. That is to say that when the collet is threaded onto an outer, internally threaded holder is and the collet is screwed to the holder, relative movement of a tapered outer portion of the collet along the holder drives the collet together and tightens the grip on the pipe. To relieve the grip the collet is turned in the opposite direction, allowing the collet to open out and so to release the pipe. This avoids the aforementioned problem known in the art, whereby the operator must simultaneously push the collet and pull out the pipe. In the present invention, all that is required is for the operator to unscrew the collet holder and subsequently withdraw the pipe.

The ease of connection and disconnection of pipes that is provided by the present invention makes the inventive assembly ideal for connecting fluid-carrying pipes or tubes, for example water pipes. The invention finds application in carrying hot and cold water for heating and cooling pipe assemblies. The inventive assembly is also useful in connecting water pipes in an irrigation system, which may be a temporary, modular or expandable irrigation system. As the pipes of the irrigation system can easily be interchanged using the assembly of the invention, the irrigation system can easily be extended to irrigate a larger area, or made smaller, by addition or removal of pipes.

The assembly of the invention is also useful in connecting pipes, rods or tubes in the construction of a structure or construction that is supported by pipes, rods, or tubes, for example a tent structure, marquee or solid-wall structure that is nevertheless based on a pole framework. The ease of connection of the poles which is provided by the assembly of the invention means that said structure, which may be a temporary structure, means that the structure can be rapidly assembled and disassembled.

According to the present invention, there is provided a connection assembly for connecting a pipe, rod or pole to a connector, the assembly comprising:

a collet having at a first end thereof a collet head having at least one abutment and at the second end thereof a collet collar, the collet having a bore therethrough, the collet bore being dimensioned and configured to receive and fittingly engage the pipe, rod or pole, the collet head being resiliently deformable so as to impinge on the pipe, rod or pole when deformed inwardly, the collet being provided with at least one screw thread on the external surface of the collet; and

a collet holder having a collet holder bore therethrough, the collet holder bore being dimensioned and configured to receive the collet, the collet holder bore comprising at least one screw thread on the surface thereof which matches the thread of the collet;

wherein in use the collet holder and collet are mutually rotatable about a collet screw thread and a collet holder screw thread to cause relative transverse movement between the collet and collet holder whereby the collet holder impinges on an abutment of the collet head to deform the collet head, thereby impinging on and gripping the pipe, rod or tube.

Preferably, the assembly further comprises:

a collet deflector dimensioned and configured to receive an abutment of the collet;

wherein in use relative transverse movement between the collet and the collet holder causes the collet to engage with the collet deflector, whereby the collet deflector impinges on the abutment of the collet head to deform the collet head, which thereby impinges on and grips the pipe, rod or tube.

According to the present invention, there is also provided a connection assembly for connecting a pipe, rod or pole to a connector, the assembly comprising:

a collet having at a first end thereof a collet head having at least one abutment and at the second end thereof a collet collar, the collet having a bore therethrough, the collet bore being dimensioned and configured to receive and fittingly engage the pipe, rod or pole, the collet head being resiliently deformable so as to impinge on the pipe, rod or pole when deformed inwardly, the collet being provided with at least one screw thread on the external surface of the collet;

a collet holder having a collet holder bore therethrough, the collet holder bore being dimensioned and configured to receive the collet, the collet holder bore comprising at least one screw thread on the surface thereof which matches the thread of the collet; and

a collet deflector dimensioned and configured to receive an abutment of the collet;

wherein in use the collet holder and collet are mutually rotatable about a collet screw thread and a collet holder screw thread to cause the collet to engage with the collet deflector, whereby the collet deflector impinges on an abutment of the collet head to deform the collet head, which thereby impinges on and grips the pipe, rod or tube.

Preferably, the collet deflector is a substantially O-shaped ring having an internal surface that matches, at least in part, an abutment of the collet.

Conveniently, the internal surface of the collet deflector is chamfered.

Advantageously the angle of the chamfer is 40 degrees.

Preferably the connection assembly further comprises a retaining means to retain the collet in the collet holder.

Advantageously the retaining means passes through a radial bore in the collet holder and engages with the collet thereby preventing relative movement between the collet and the collet holder.

Conveniently the retaining means is a pin or screw.

Preferably the collet holder further comprises a gripping portion to allow the collet holder to be manipulated.

Advantageously the collet comprises a gripping portion to allow the collet to be manipulated.

Conveniently the gripping portion or portions comprises spanner flats or a hexagonal section.

Preferably the collet head further comprises an inwardly directed lip for exerting concentrated force on the pipe, rod or tube when the collet head is deformed.

Advantageously the collet holder further comprises engagement means for engaging with the connector.

Conveniently the engagement means comprise a screw thread on an external surface of the collet holder which is dimensioned and configured to engage with a correspondingly dimensioned and configured screw thread provided on the connector.

Alternatively the engagement means comprise at least one barb provided on an external surface of the collet holder, said barb or barbs penetrating the connector or being housed in corresponding recesses in the connector in use.

Alternatively the engagement means comprise a circumferential groove or grooves provided in the collet holder for housing adhesive for adhesive engagement with the connector.

Preferably the assembly further comprises an O-ring for sealing the collet in the connector.

Conveniently the collet holder comprises a circumferential projection in the region of the collet holder to be engaged with the collet head, the circumferential projection being dimensioned and configured to at least partially house the O-ring.

Advantageously the abutment comprises a region of the collet head that has increasing external diameter in the direction from the collet collar at the second end of the collet to the collet head at the first end of the collet.

Preferably the abutment comprises a circumferentially flared portion.

Preferably the abutment comprises a circumferential lip.

Conveniently the collet holder comprises a region that has decreasing internal diameter from the direction of the part of the collet holder to be engaged with the collet head.

Preferably the region having decreasing internal diameter comprises an inwardly flared region.

Advantageously the region having decreasing internal diameter comprises a circumferential step.

The invention also provides a connector for connection to a pipe, rod or tube, the connector comprising a fluid-impermeable body, the body having a bore having a first region of diameter dimensioned and configured to fittingly receive the pipe, rod or tube, the bore having at least one second region of diameter dimensioned and configured to fittingly receive the connection assembly according to the invention.

The invention furthermore provides a kit for connecting a pipe, rod or tube to a connector, the kit comprising at least one connection assembly according to the invention together with at least one connector according to the invention.

### BRIEF DESCRIPTION OF THE DRAWINGS

Embodiments of the invention are described below with reference to the accompanying drawings in which:

FIG. 1 depicts, in partial cross-section, a collet to be employed in the pipe connection assembly of the present invention;

FIG. 2 depicts an enlarged portion of the collet of FIG. 1, the enlarged portion of FIG. 1 being shown pictorially within a circle and the letter A;

FIG. 3 is a perspective view of the collet of FIG. 1;

FIG. 4 is a perspective view of a collet holder to be employed in the pipe connection assembly of the present invention;

FIG. 5 is a perspective view of a connection assembly according to the present invention;

FIG. 6 is a cross-sectional view of a connection assembly according to the present invention;

FIG. 7 is a cross-sectional view of a further connection assembly according to the present invention;

FIG. 8 is a cross-sectional view of a still further connection assembly according to the present invention;

FIG. 9 is a cross-sectional view of a yet further connection assembly according to the present invention;

FIG. 10 is a partial cross-section, an alternative collet to be employed in the pipe connection assembly of the present invention;

FIG. 11 is a cross-sectional view of an alternative connection assembly according to the present invention;

FIG. 12 is a cross-sectional view of a further alternative connection assembly according to the present invention;

FIG. 13 is a partial cross-section of an alternative collet to be employed in the pipe connection assembly of the present invention;

FIG. 14 is a partial cross-section of an alternative collet to be employed in the pipe connection assembly of the present invention, together with a collet deflector;

FIG. 15 is a side view of the collet and collet deflector of FIG. 14 together with an O-ring, ready for assembly on a pipe;

FIG. 16 is a partially cut away side view of an alternative connection assembly according to the present invention;

FIG. 17 is a side view of a collet holder to be employed in an alternative connection assembly of the invention; and

FIG. 18 is a cross-section of the connection assembly of FIG. 17.

### DESCRIPTION OF THE EXAMPLE EMBODIMENTS

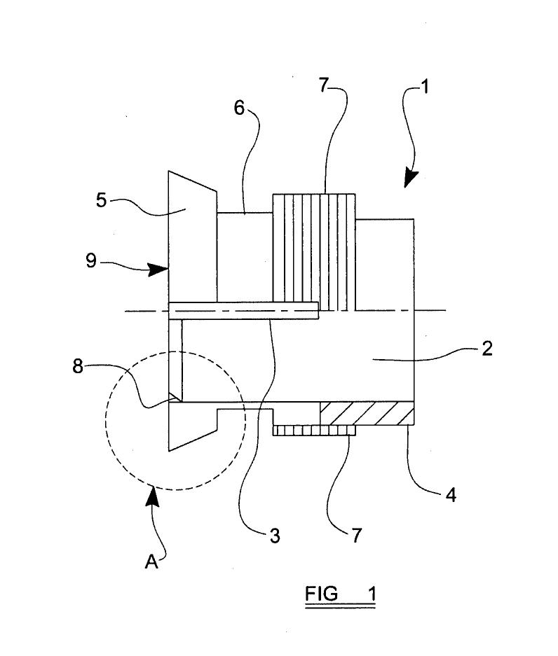

Referring now to FIG. 1, the collet 1 of the invention is shown in partial cross-section and is provided with an internal bore 2 to which is dimensioned and configured to receive the outside diameter of a particular pipe (not shown). The bore 2 is therefore substantially circular in cross section and has equal diameter along its length. The collet 1 is substantially cylindrical in configuration and is split along the sidewall thereof with four longitudinal slots 3. It is to be appreciated that a different number of slots 3 could be provided, depending upon the diameter of the pipe to be connected; for example, one, two, three, four or more than four slots 3 could be provided. A larger pipe will generally require a larger number of slots 3. Four slots 3 are particularly favoured because the slots 3 can be equally spaced about the collet 1, each 90 degrees of the diameter of the collet 1 apart, leading to a symmetrical arrangement. The slots 3 provide resiliency to the sidewall of the collet 1, referred to below as the collar 6 of the collet.

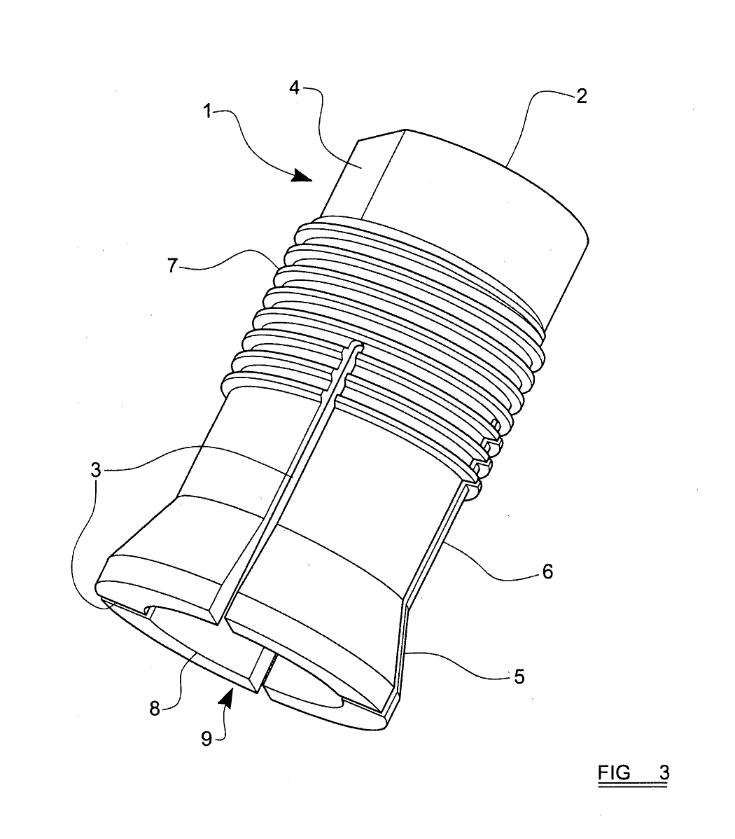

As depicted in FIG. 1, and as can also clearly be seen from FIG. 3, the collet 1 is also provided with a pair of “spanner fiats” 4 at one end thereof, and a collet head 5 at the opposed end thereof. A spanner flat 4 is a squared-off or flattened section of the otherwise substantially cylindrical collet 1, that allows the collet 1 to be gripped by a spanner and thereby tightened or loosened with respect to a pipe to be gripped. Other methods of tightening and loosening could also be employed; for example the end of the collet 1 could also be of hexagonal formation.

The collet collar 6 is provided with screw thread 7 around the circumference thereof. Whilst in the embodiment shown, just one continuous screw thread 7 is depicted, it would of course be possible to provide a multiple-start thread, or multiple threads.

The head 5 of collet 1 is tapered i.e. flared outward in the direction moving from the thread 7 to the head 5. However, the internal bore 2 of the collet is of substantially similar cross-section throughout, as shown in FIG. 1, so that a pipe of matching cross-section can be inserted therein and held.

As will be described in more detail below, in the depicted embodiment the flared configuration of collet head 5 is used to drive the collet 1 closed. However it is possible that other configurations of collet head could be used; for example, an unflared collet head (such that the entire collet is of substantially identical diameter) could also be employed if provided with some sort of abutment or area of greater diameter to interact with the collet holder 10 described below. For example a circumferential lip; or one or more protrusions provided on collet head 5 would have the desired effect.

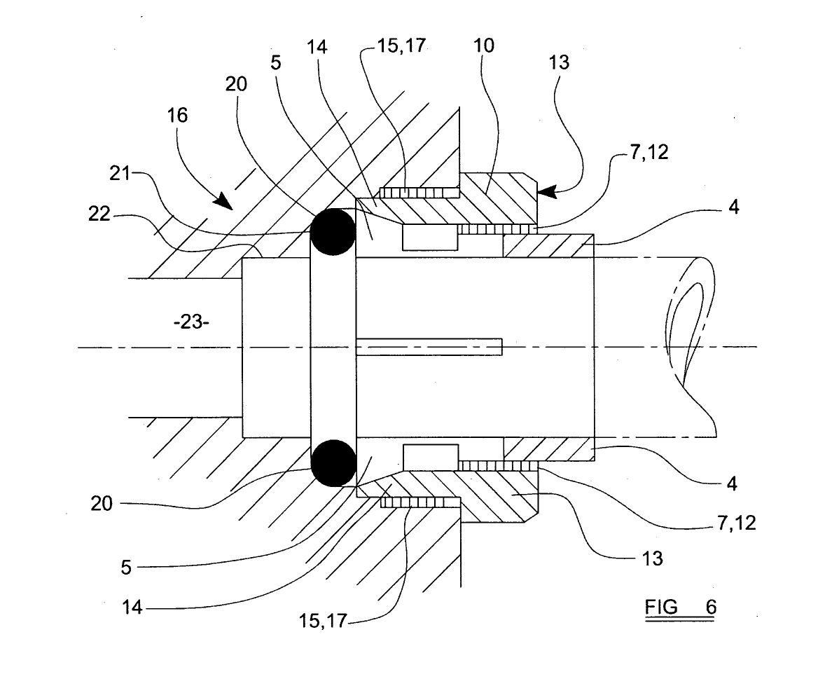

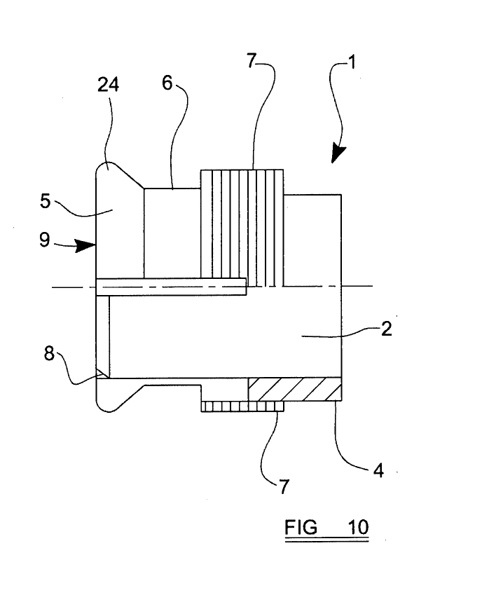

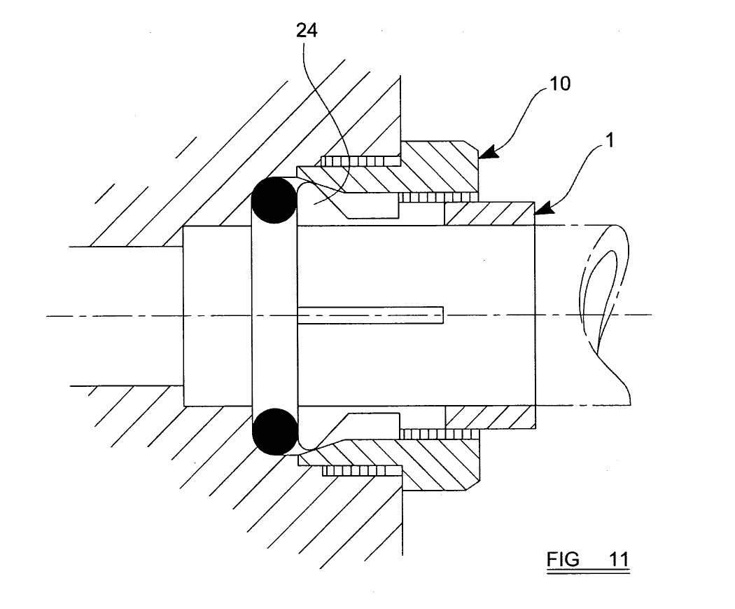

In the embodiment pictured in FIGS. 1-9 and 12, the abutment takes the form of a flared head 5. However, FIGS. 10 and 11 depict an alternative embodiment of the invention in which the abutment is a circumferential lip 24. Other than the circumferential lip 24, FIGS. 10 and 11 are identical in all respects to FIGS. 1 and 6, with like reference numerals.

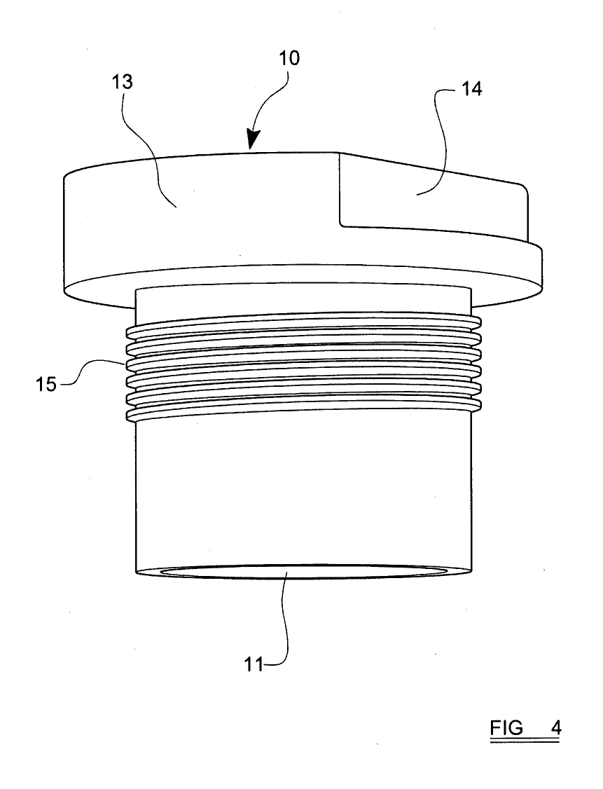

The assembly of the invention also comprises a collet holder 10 which is depicted in FIG. 4. The collet holder 10 has an internal bore 11 therethrough, and the bore is at least partially or fully threaded 12 on its interior surface (see FIG. 6). The collet holder 10 is also substantially cylindrical in configuration. The thread 12 of the collet holder 10 is dimensioned and configured to be threadedly engaged with the threaded portion 7 of the collet 1. This is depicted most clearly in FIG. 6, which shows the threads 7 and 12 of the collet 1 and collet holder 10 respectively, in the engaged configuration.

The collet holder also has a gripping portion 13, which as shown in FIG. 4 is a region of increased diameter in comparison to the rest of holder 10. The gripping portion 13 is provided with spanner flats 14, which allow the holder to be gripped and manipulated by a spanner.

The internal bore 11 of the collet holder 10, as shown in FIG. 6, comprises a region of equal internal diameter, at the end of the collet holder 10 nearest the gripping portion 13. In addition there is a tapered region 14 of the collet holder 10 whereby the internal diameter of the collet holder 10 increases in the direction away from the gripping portion 13. As will be described below, the tapered end 14 of the holder 10 engages in use with the equivalently flared head 5 of the collet 1, as depicted. However, the internal bore 11 of the collet holder 10 could also be equal along the length of the holder 10, and would also interact with the flared head 5 of the collet 1. An equal internal bore 11 could also be employed where the abutment of the collet head 5 is not flared but is a lip 24, or series of protrusions.

In any event, the dimension of the collet holder 10 is such that it is receivable by the narrowest end of the collet 1, i.e. in the region of the spanner flats 4. Thus the internally threaded 12 holder 10 is to be threaded with the threaded portion 7 of collet 1 by virtue of the mutually threadable screw threads 7 and 12. As the collet 1 is crewed into holder 10, the tapered end 14 of the holder 10 urges against the flared head 5 of collet 1. Due to the provision of slots 3 in the collar 6, said urging forces together the portions of the collar 6 adjacent the slots 3, thereby tending to close up the slots 3. Said forcing together of the head 5 of the collar 3 will cause the head 5 to impinge on a pipe placed within the bore 2 of the collet, thereby tending to clamp the pipe in the collet 1.

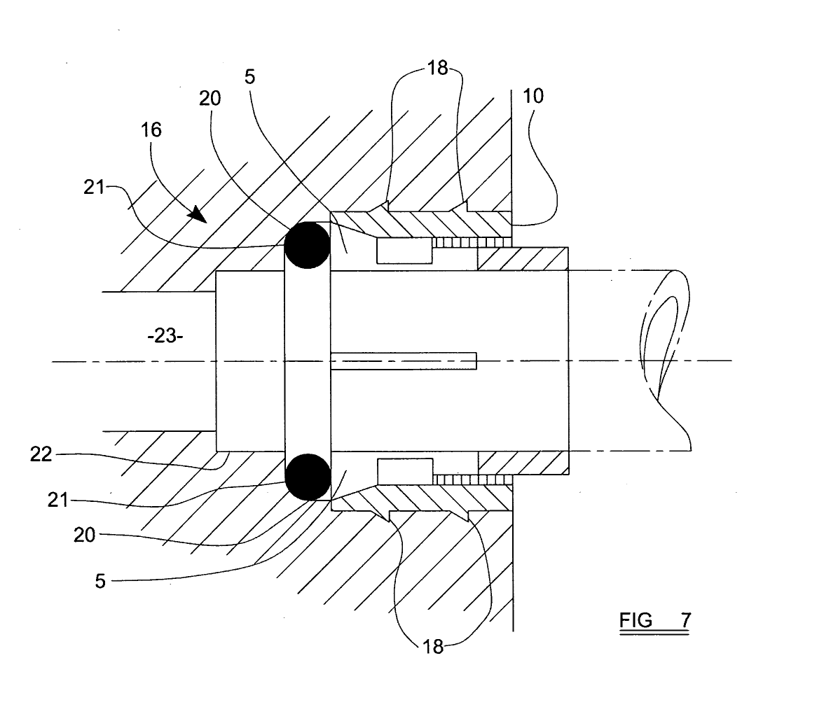

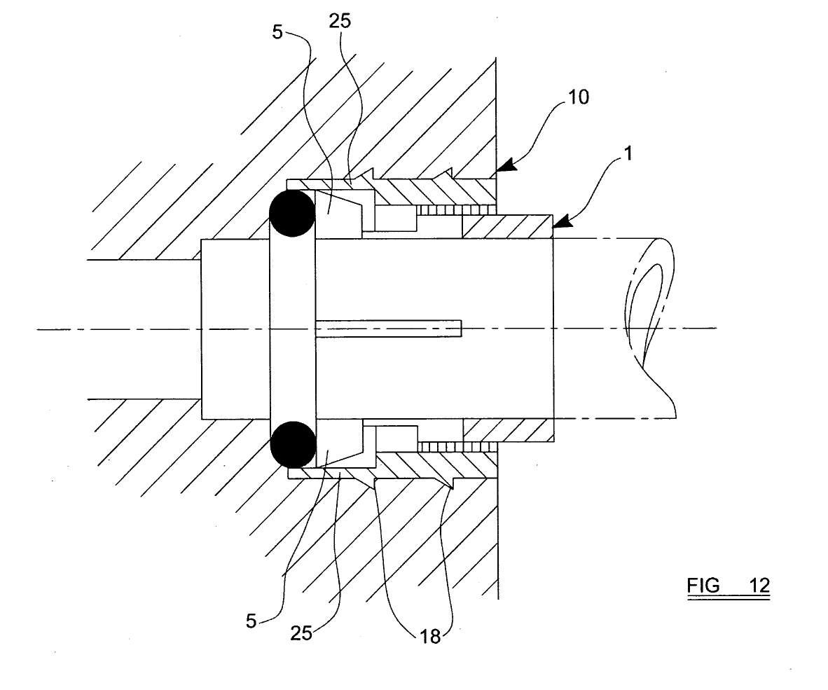

FIG. 12 shows a modified version of the collet holder 10. FIG. 12 is otherwise identical to FIG. 7, with like reference numerals, except that the taper 14 of the collet holder 10 is replaced by a step 25. Step 25 takes the configuration of a portion of reduced diameter in the collet holder 10. Thus, rather than a gradually decreasing internal diameter of the collet holder 10, as in the case of the taper 14, the step 25 provides a sudden decrease in internal diameter, with no gradual change. However, the step 25 has the same action as the taper 14, namely impinging on the head 5 of collet 1.

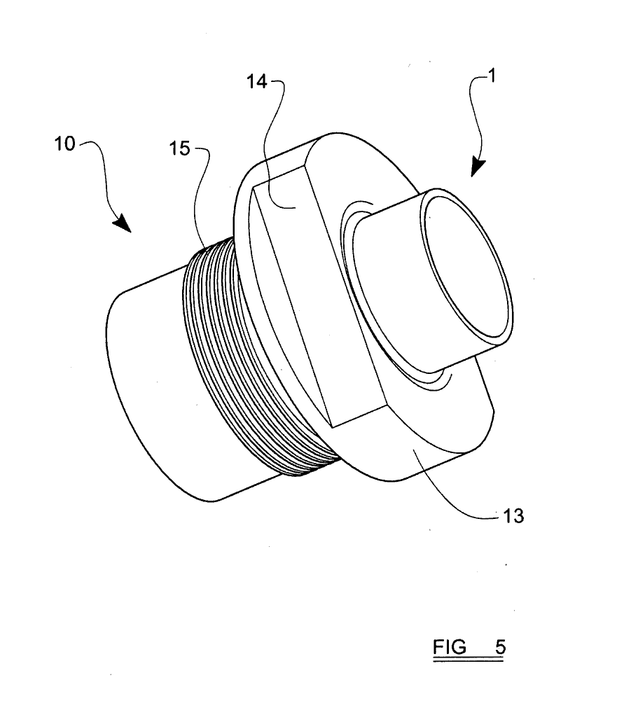

Whilst the method of operation has been described above with reference to the collet 1 being screwed onto the collet holder 10, it is to be appreciated that equally the collet holder 10 could be screwed in to the collet 1, which would have the same method of action. In sum, it is the relative movement of the collet holder 10 against the flared head 5 of the collet 1 which causes the head 5 to deform inwardly, thereby gripping a pipe. FIG. 5 depicts the completed assembly of the collet 1 and collet holder 10.

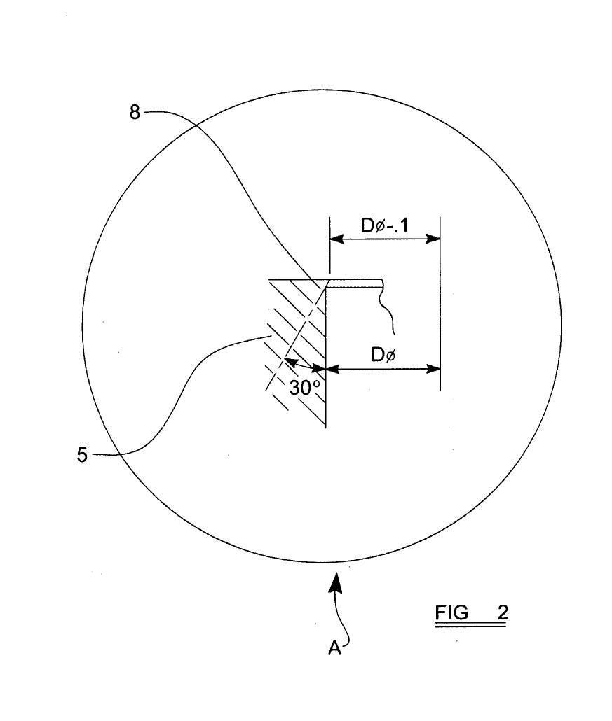

FIG. 2 depicts a blown-up portion of the collet 1 and in particular the collet head 5 shown in FIG. 1. The blown-up portion has been circled in FIGS. 1 and 2 and has been designated with the letter A. Within the mouth 9 of the collet head 5 there is provided a chamfered internal lip 8. This lip 8 serves to concentrate gripping stress at the tip of the lip 8, so that the lip 8 may penetrate, to a limited degree, into the outer diameter of the inserted pipe. This lip 8 is particularly important when the assembly is used with soft pipe materials such as, for example, nylon. The chamfer of the collet head 5 is chosen for safety considerations; so that when the complete assembly is in situ, the collet 1 cannot be withdrawn.

The angle of the chamfer of the lip 8 is 30 degrees as depicted. However it is to be appreciated that other angles could be used for the chamfer, being less than 90 degrees but greater than zero degrees, for example 10 to 80, 20 to 60 or 45 degrees.

Turning once more to FIG. 6, which depicts a cross section of one embodiment of the invention, one embodiment of the collet holder 10 is shown. In this embodiment, the holder has an external thread 15 (also clearly seen in FIG. 4). The external thread 15, together with the gripping portion 13, comprising spanner flats 14, allows the collet holder 10 to be screwed into connector 16 which will be described in more detail below. In the embodiment of FIG. 6, the connector 16 has a bore which is partially internally threaded 17. The external thread 15 of the collet holder 10 is threadably engageable with the thread 17 of the connector 16, therefore allowing the assembly of collet holder 10 and collet 10 to be screwed into the connector 16.

Alternatively, as shown in FIG. 7 (which is equivalent in other respects to FIG. 6) the outside surface of the holder 10 can be furnished with one or more external barbs 18 which are deformable. The barbs 18 can be one or more discrete projections or could, for example be a deformable lip around the outside circumference of the holder 10. In this embodiment there is no gripping portion 13 because the holder 10 can simply be pushed into the connector 16. The connector 16 may be provided in the bore thereof a recess or recesses, or a circumferential groove in order to accommodate barbs 18. As shown, the barbs 18 are backwardly deflected such that once the holder 10 is pushed into connector and the barbs 18 have deformed and subsequently been located in the recess(es) or groove(s) the barbs 18 become difficult, if not impossible, to remove from the recess(es) or groove(s), due to the frontward slope of the barbs 18 and the rearward wall of the barbs 18. Alternatively, the barbs 18 could simply penetrate the constructional material of the connector 16 where the connector 16 is of a relatively soft material such as nylon. Said penetration of the barbs 18 also successfully locates the holder 10 in the bore of connector 16.

In yet an alternative embodiment of the invention (not shown) the threaded arrangement of FIG. 6 or the barbed arrangement of FIG. 7 could be either replaced or augmented by one or more recesses or grooves provided in the bore of the connector 16 and/or the external circumference of the holder 10. Said recesses and/or grooves are used to hold adhesive in order to adhesively locate the holder 10 within the bore of the connector 16.

One advantage of the threaded assembly (FIG. 6) is that the collet 1 and holder 10 assembly can be reversibly screwed into and out of the connector 16. The barbed assembly (FIG. 7) or adhesive assembly have the advantage of simplicity but are essentially irreversible or will cause damage to the connector upon removal of the collet holder 10.

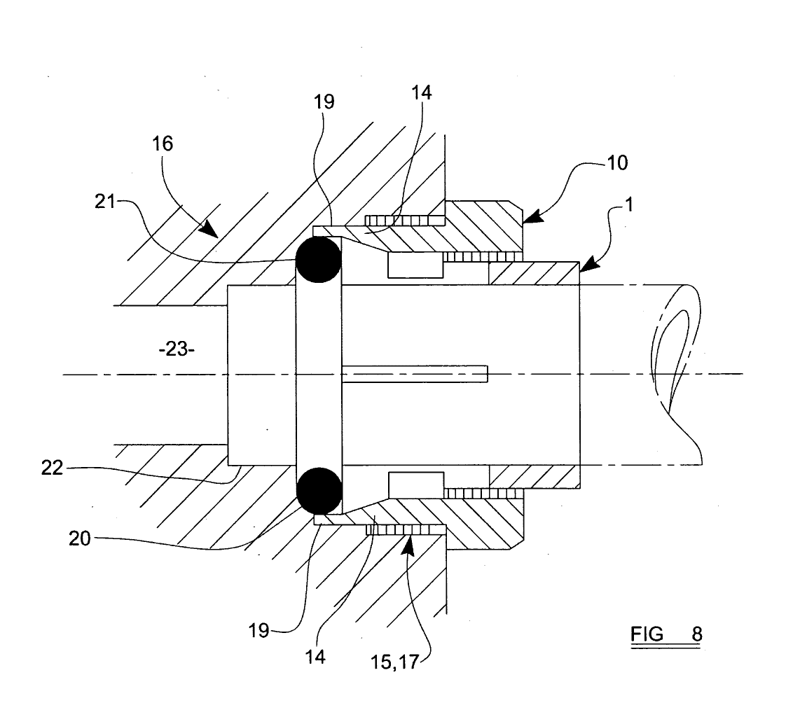

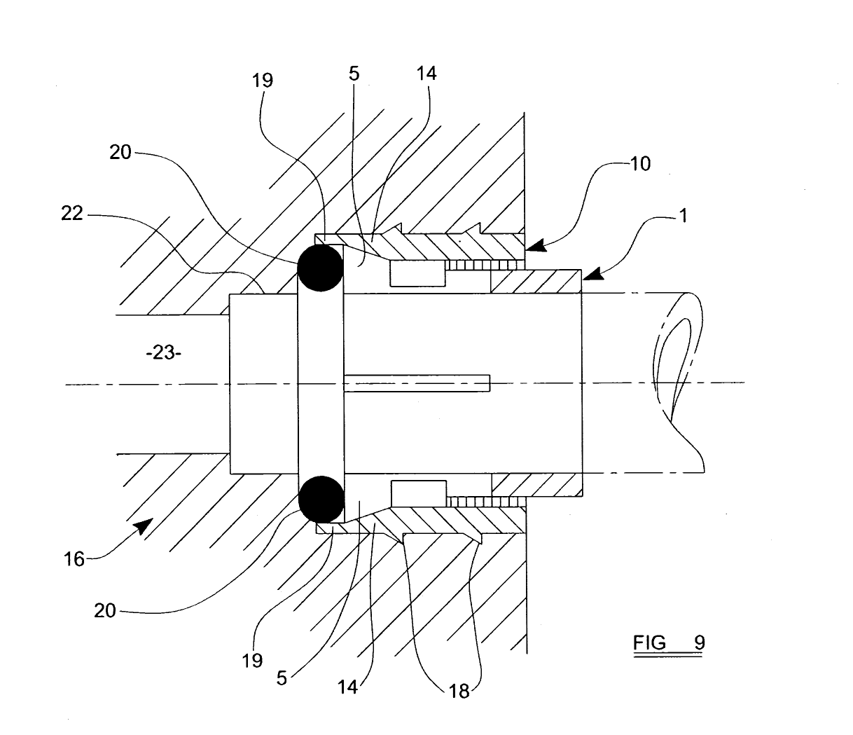

In the embodiment of the invention shown in FIGS. 8 and 9, the non-threaded end of the holder 10, i.e. beyond the tapered region 14 additionally has a circumferential projection 19 which extends beyond the internal taper 14. The purpose of this projection 19 is to accept an O-ring of reasonably large cross sectional diameter. In use, as shown, the recess created by the projection 19 is slightly smaller than the cross section of the O-ring 20. The bore of the connector 16 can also be dimensioned and configured, in this case rounded off, to accommodate fittingly the O-ring 20. The combined recess formed by the shaped bore and circumferential projection 19 is slightly smaller than the thickness of the O-ring 20 such that in use, the O-ring is subject to a slight degree of compression, causing it to seal on the outside diameter of a pipe being connected, and the bore of the connector 16. Thus the O-ring sealingly connects the assembly 1, 10 to the connector 16 so that fluid can be maintained in the system.

The relatively large cross section O-ring 20 has a second function, serving as a compressible thrust member, transferring thrust to urge the collet 1 further into the gripping condition. In order to allow this function, the fit of the collet thread 7 is made to a relative slack fit.

In another embodiment where, perhaps, space, cost, or the choice of O-ring, may be limited, the projection 19 may be absent (see FIGS. 6 and 7) but a larger recess 21 is formed in the bore of the connector 16 so that the O-ring 20 is still held in place at the extremity of the taper 14 of the collet holder 10.

Turning briefly to describe the connector 16, depicted in FIGS. 7 to 9, the connector 16 is essentially a body having a bore therethrough. FIGS. 7 to 9 depict just one side of a connector 16, and therefore one end of a bore is shown. As depicted, the opening of the connector bore is of a first diameter which is sufficient to engage with the assembly 1, 10 of the invention, which is—of course—of larger diameter than the pipe to be connected.

Beyond the sealing point of the assembly, i.e. beyond the O-rings 20 when moving in a direction away from the opening of the bore of the connector 16, there is provided a region of bore 22 which is of substantially identical diameter or of very slightly larger diameter to the pipe to be connected, so as to provide a fit to the pipe. This region 22 is provided to give stability to the pipe once gripped by the assembly 1, 10 and this region should be of a length not less than one third of the pipe diameter. This region is intended primarily as a support for the pipe, but in applications using a plastics pipe such as nylon, the length of pipe protruding from the assembly 1, 10 is advisable to allow the pipe to regain its full diameter after being subjected to the squeezing effect of the collet 1.

Further still away from the opening of the connector bore, there can be provided a region 23 of the connector bore which is narrower in diameter than the pipe. As above, the connector 16 can be a body having a bore and two bore openings. It is therefore to be appreciated that the second bore opening of the connector can be identical to the first bore opening for receiving a second assembly of collet 1 and collet holder 10, so that two pipes can similarly be attached to the connector. This arrangement is suitable for joining identical pipes, and could for example be used also when connecting two poles for framing a temporary building.

Alternatively, the connector 16 could have just one bore opening to receive one collet holder 10 and one collet 1. As described above, the bore has a suitable diameter for receiving the assembly 1, 10, fitting the pipe and possibly having a region of narrower diameter bore. The user can then drill into the connector to provide his or her own second opening to the bore and can provide his or her own attachment to the connector 16 in this way. For example, where the pipe being connected to the assembly by the collet 1 and holder 10 is a water pipe, the user might wish to provide a different type of attachment such as a manifold to the connector 16.

In use, the collet holder 10 can be permanently affixed to the connector 16 using the barbed 18 or adhesive arrangements described above. In use, the collet 1 must therefore be screwed into the collet holder 10. Similarly the connect 16 can be supplied in use screwed onto the screw-type collet holder 10 depicted in FIG. 6. Again, therefore, the user must screw the collet 1 into the collet holder 10 in use.

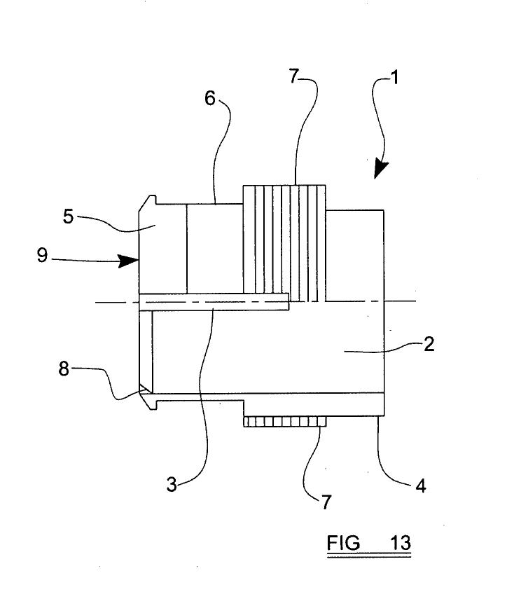

Referring now to FIG. 13, there is depicted an alternative collet for use in an alternative embodiment of the present invention. The collet of FIG. 13 corresponds in all respects to the collet of FIG. 1, and like reference numerals are used. However, it is clear to see that the abutment at the collet head 5 in FIG. 13 is very much smaller than the abutment of the collet head 5 in the collet of FIG. 1. Indeed, the embodiment described here and shown in FIGS. 13-18, having a small abutment on the collet head 5, presents a smaller connection system than the arrangement for example of FIG. 1.

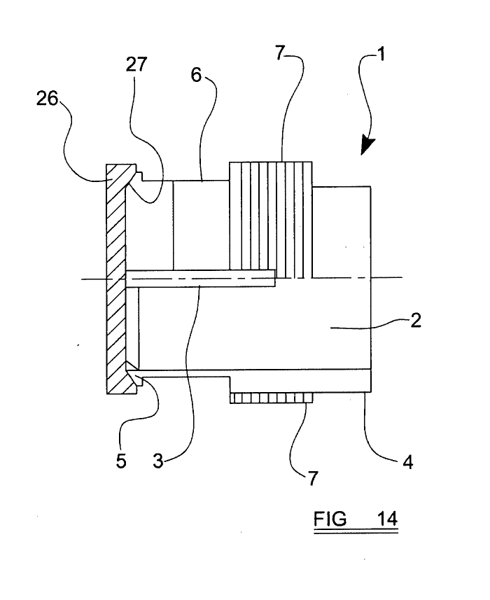

FIG. 14 shows the same collet as FIG. 13 together with collet deflector 26. Here, collet deflector 26 is a rigid O-ring and the internal surface of the O-ring is chamfered to match the sloped shape of the abutment of collet head 5. The chamfered surface 27 as shown has an angle of chamfer which is approximately 40 degrees. However, it is appreciated that any other suitable angle could be used, for example an angle of 30-70 degrees or preferably 30-60 degrees. In any event, the angle of chamfer 27 matches the shape of the collet head 5 abutment.

The mode of action of the collet 1, shown in FIGS. 13 and 14 is exactly the same as the collet shown in FIG. 1, i.e. the collet 1 can deform inwardly when the longitudinal slots 3 close up. Looking at FIG. 14, it can be appreciated that when the collet 1 is moved from right to left in the figure, such that the abutment of collet head 5 is received by the collet deflector 26, as the collet 1 engages with the collet deflector 26 the abutment of collet head 5 will slide against the chamfered surface 27, and the longitudinal slots 3 will close up, thereby deforming the collet 1 inwardly and gripping any tube, pipe or rod which is contained within the collet 1. This mode of operation is identical to the other collet arrangements described in this application.

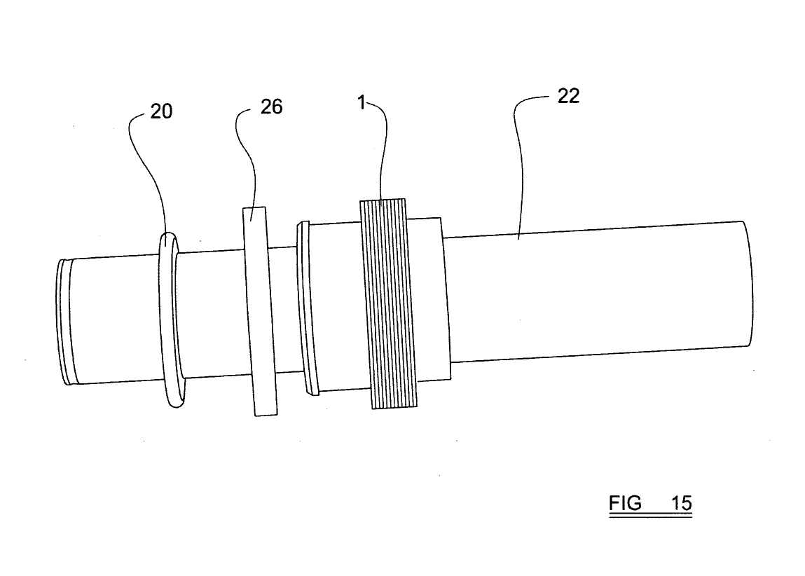

FIG. 15 shows a pipe 22. A collet 1 according to FIG. 13 has been mounted on the pipe, together with the collet deflector 26 and a sealing O-ring 20. The pipe 22, together with the connection assembly components is therefore ready to be inserted into a collet holder.

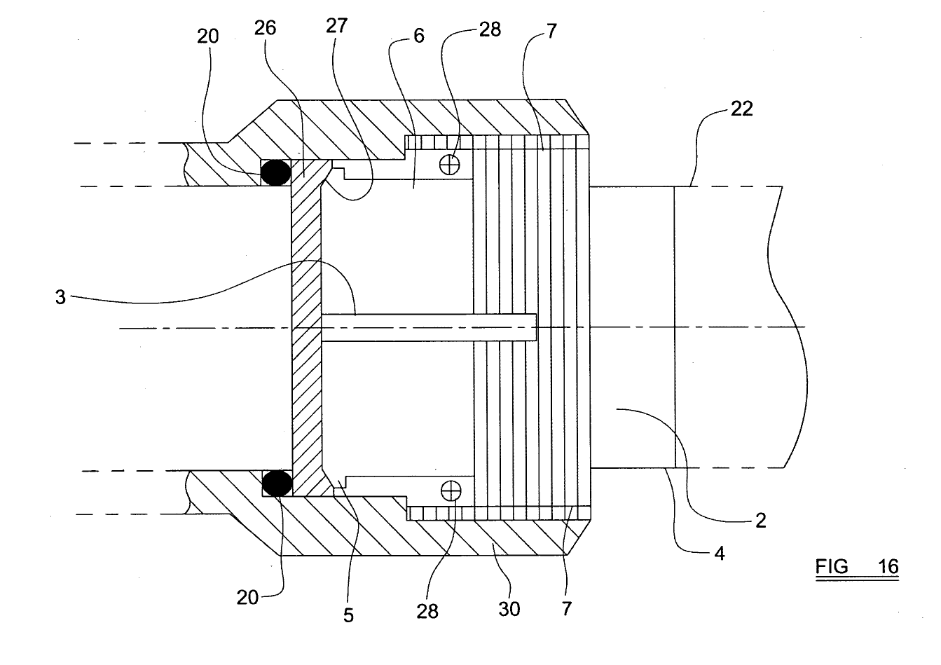

In FIG. 16, a collet holder 30 is shown. The pipe 22, collet 1, collet deflector 26 and O-ring 20 from FIG. 15 have been inserted into the collet holder 30. The collet holder 30 has a screw thread on its internal surface that matches the screw thread of the collet 1. Once the sealing O-ring 20 is seated inside the collet holder 30, the collet deflector 26 will urge against the O-ring 20. As collet 1 is screwed into collet holder 30, eventually the head 5 of the collet 1 will come into contact with the chamfered surface 27 of the collet deflector 26. As screwing is continued, the collet 1 continues to move from right to left as shown in FIG. 16 and, as described above, the collet head 5 will be inwardly deflected by means of the longitudinal slots 3 closing up. Thus, the collet 1 will grip the pipe 22 in the region of collet head 5 and the collet 1 itself is retained by the screw thread of the collet and the collet holder. Thus, the pipe 22 is gripped within the combination of collet 1 and collet holder 30.

As an additional means of holding the arrangement in place, the connection assembly is provided with a retaining means 28, which in this case is a screw or pin 28. The pin 28 passes through a radial bore in the collet holder 30 so that the end of the pin 28 which has passed through the collet holder 30 becomes located in an aperture between the collet head 5 and the collet screw thread. The pin 28 therefore prevents the collet 1 from falling out of the holder 30 because collet head abutment 5 is prevented from passing the pin 28 due to the enlarged size of the abutment.

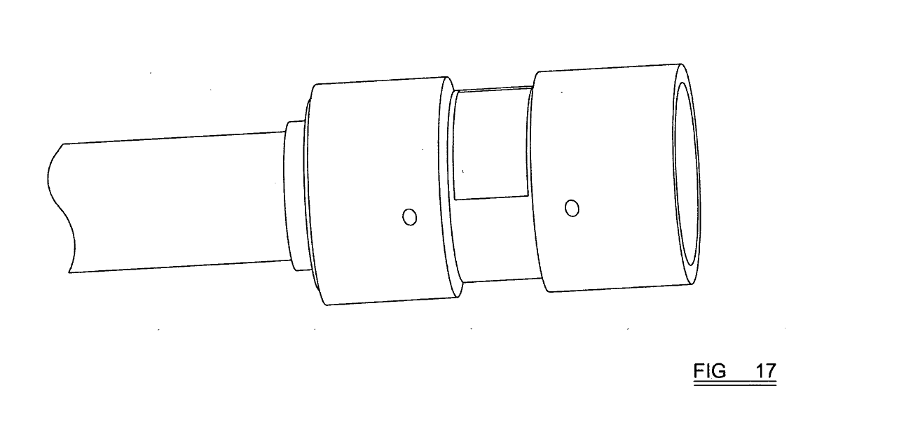

FIG. 17 shows a particular collet holder that could be used in the arrangement of FIG. 16, in which a bore 29 can clearly be seen in the collet holder 13. The bore 29 is dimensioned and configured to receive the pin 28 therethrough.

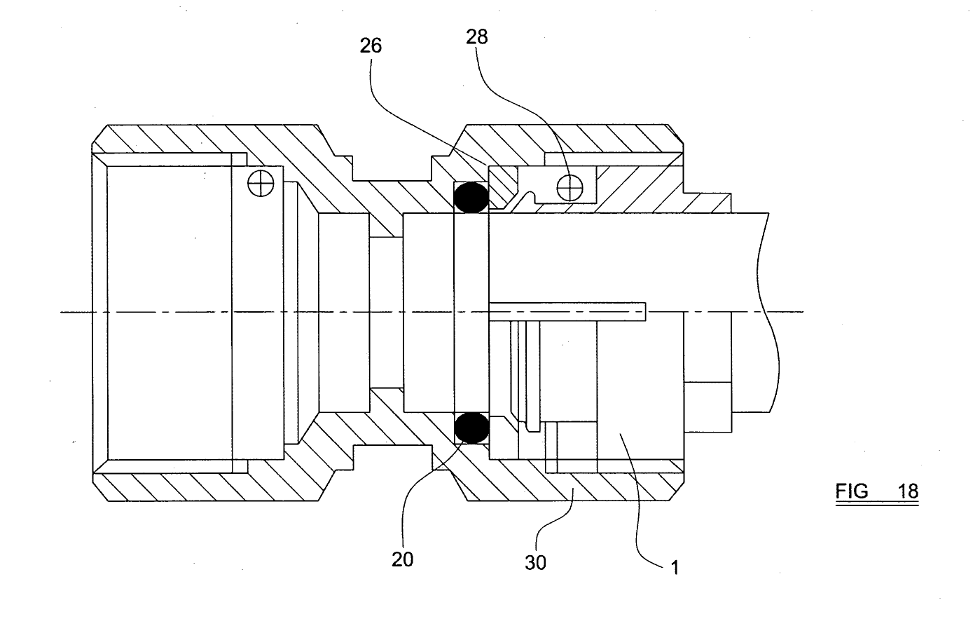

The arrangement shown in FIG. 17 is essentially two of the collet holders 30 as shown in FIG. 16 joined together. Thus, each end of the collet holder 30 of FIG. 17 receives a corresponding collet 1. In this manner, two pipes 22 of identical diameter can be received and connected by means of two corresponding collets 1 engaged with two joined connectors 30. FIG. 18 shows a cross-section of this arrangement.

However, it is to be appreciated that the connection assembly does not necessarily need to have two identical connectors 30. For example, there could be one collet holder 30 as shown in FIG. 16 together with a further collet holder of different diameter, in order to connect two pipes, rods or tubes of different diameters. Alternatively, one of the collet holders 30 of FIG. 17 could be replaced by a manifold or distribution arrangement, providing connection to a number of pipes, rods or tubes. This kind of arrangement would be particularly beneficial in a horticultural or irrigation system. Similarly, one of the collet holders 30 of FIG. 17 could be provided at an angle, i.e., where the middle portion 31 as shown in FIG. 17 is angled.

The arrangement shown in FIGS. 13-18 has a smaller cross-sectional profile than the arrangement of FIG. 1-12 and is particularly well suited to irrigation arrangements or for connecting pipes, rods or tubes for constructional purposes. As will be appreciated, in the embodiment of FIGS. 13-18, a separate connector to house the collet holder 30 is not required because the collet holder 30 itself acts as the connector.

The embodiment of FIGS. 13-18 is therefore suitable for connecting pipes having relatively small diameters, such as 15 mm or 8 mm. This is due to the relatively small cross-section of the arrangement of this embodiment.

The invention described here also includes a kit for connecting pipes, rods or tubes which comprises at least one collet 1, at least one collet holder 10 together with a connector and preferably an O-ring. The assembly of the invention may be made from any machinable or die cast metal, machinable plastics, or semi-rigid mouldable plastics.

It has been found that the assembly of the present invention grips pipes, tubes or rods very tightly and rigidly. Not only can the assembly be used in simple fluid transfer applications, but the assembly can also be used securely to connect construction pipes, rods or poles in the assembly of unconventional buildings.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A connection assembly for connecting a pipe, rod or pole to a connector, the assembly comprising:
a collet having at a first end thereof a collet head having at least one abutment and at the second end thereof a collet collar, the collet having a bore therethrough, the collet bore being dimensioned and configured to receive and fittingly engage the pipe, rod or pole, the collet head being resiliently deformable so as to impinge on the pipe, rod or pole when deformed inwardly, the collet being provided with at least one screw thread on the external surface of the collet; and
a collet holder having a collet holder bore therethrough, the collet holder bore being dimensioned and configured to receive the collet, the collet holder bore comprising at least one screw thread on the surface thereof which matches the thread of the collet; and
wherein in use the collet holder and collet are mutually rotatable about a collet screw thread and a collet holder screw thread to cause relative transverse movement between the collet and collet holder whereby the collet holder impinges on an abutment of the collet head to deform the collet head, thereby impinging on and gripping the pipe, rod or tube.

2. A connection assembly according to claim 1, wherein the assembly further comprises:
a collet deflector dimensioned and configured to receive an abutment of the collet; and
wherein in use relative transverse movement between the collet and the collet holder causes the collet to engage with the collet deflector, whereby the collet deflector impinges on the abutment of the collet head to deform the collet head, which thereby impinges on and grips the pipe, rod or tube.

3. A connection assembly according to claim 2, wherein the collet deflector is a substantially O-shaped ring having an internal surface that matches, at least in part, an abutment of the collet.

4. A connection assembly according to claim 3, wherein the internal surface of the collet deflector is chamfered.

5. A connection assembly according to claim 4, wherein the angle of the chamfer is 40 degrees.

6. A connection assembly according to claim 1, further comprising a retaining means to retain the collet in the collet holder.

7. A connection assembly according to claim 6, wherein the retaining means passes through a radial bore in the collet holder and engages with the collet thereby preventing relative movement between the collet and the collet holder.

8. A connection assembly according to claim 6, wherein the retaining means is a pin or screw.

9. A connection assembly according to claim 1, wherein the collet holder further comprises a gripping portion to allow the collet holder to be manipulated.

10. A connection assembly according to claim 1, wherein the collet comprises a gripping portion to allow the collet to be manipulated.

11. A connection assembly according to claim 9, wherein the gripping portion or portions comprises spanner flats or a hexagonal section.

12. A connection assembly according to claim 1, wherein the collet head further comprises an inwardly directed lip for exerting concentrated force on the pipe, rod or tube when the collet head is deformed.

13. A connection assembly according to claim 1, wherein the collet holder further comprises engagement means for engaging with the connector.

14. A connection assembly according to claim 13, wherein the engagement means comprise a screw thread on an external surface of the collet holder which is dimensioned and configured to engage with a correspondingly dimensioned and configured screw thread provided on the connector.

15. A connection assembly according to claim 13, wherein the engagement means comprise at least one barb provided on an external surface of the collet holder, said barb or barbs penetrating the connector or being housed in corresponding recesses in the connector in use.

16. A connection assembly according to claim 13, wherein the engagement means comprise a circumferential groove or grooves provided in the collet holder for housing adhesive for adhesive engagement with the connector.

17. A connection assembly according to claim 1, wherein the assembly further comprises an O-ring for sealing the collet in the connector.

18. A connection assembly according to claim 17, wherein the collet holder comprises a circumferential projection in the region of the collet holder to be engaged with the collet head, the circumferential projection being dimensioned and configured to at least partially house the O-ring.

19. A connection assembly according to claim 1, wherein the abutment comprises a region of the collet head that has increasing external diameter in the direction from the collet collar at the second end of the collet to the collet head at the first end of the collet.

20. A connection assembly according to claim 1, wherein the abutment comprises a circumferentially flared portion.

21. A connection assembly according to claim 1, wherein the abutment comprises a circumferential lip.

22. A connection assembly according to claim 1, wherein the collet holder comprises a region that has decreasing internal diameter from the direction of the part of the collet holder to be engaged with the collet head.

23. A connection assembly according to claim 22, wherein the region having decreasing internal diameter comprises an inwardly flared region.

24. A connection assembly according to claim 22, wherein the region having decreasing internal diameter comprises a circumferential step.

25. A connector for connection to a pipe, rod or tube, the connector comprising a fluid-impermeable body, the body having a bore having a first region of diameter dimensioned and configured to fittingly receive the pipe, rod or tube, the bore having at least one second region of diameter dimensioned and configured to fittingly receive the connection assembly according to claim 1.

26. A kit for connecting a pipe, rod or tube to a connector, the kit comprising at least one connection assembly together with at least one connector according to claim 25.

27. A connection assembly substantially as herein described with reference to FIGS. 1 to 18.

28. Any novel feature or combination of features described herein.
